(19) United States
(12) Patent Application Publication
(10) Pub. No.: US 2007/0264155 A1
(43) Pub. Date: Nov. 15, 2007

(54) Aerosol jet deposition method and system for creating a reference region/sample region on a biosensor

(76) Inventors: Michael D. Brady, Painted Post, NY (US); John S. Peanasky, Big Flats, NY (US); Richard C. Peterson, Elmira Heights, NY (US); Yongsheng Yan, Painted Post, NY (US)

Correspondence Address: CORNING INCORPORATED, SP-TI-3-1, CORNING, NY, 14831, US

(21) Appl. No.: 11/431,226

(22) Filed: May 9, 2006

(51) Int. Cl. G01N 31/22

(52) U.S. Cl. 422/58

(57) ABSTRACT

A method and deposition device are described herein that use an aerosol jet direct write technique to create non-binding reference region(s) and/or binding sample region(s) within a single well or multiple wells of a microplate, or on a single or multiple biosensors of an unassembled bottom insert.

### BACKGROUND OF THE INVENTION

1. Field of the Invention

The present invention relates to a biosensor that has a surface with a sample region and/or a reference region which were created in part by using an aerosol jet direct write technique. In one embodiment, the biosensor is incorporated within a well of a microplate.

2. Description of Related Art

Today a biosensor and an optical label independent detection (LID) interrogation system can be used to enable the detection of a chemical/biomolecular binding event that takes place at or near the biosensor's surface. In particular, the biosensor and the optical interrogation system can be used so that changes in a refractive index/optical response of the biosensor can be measured which in turn enables a chemical/biomolecular binding event to be detected at or near the biosensor's surface. The biosensor along with a various optical interrogation systems have been used to detect a wide-variety of chemical/biomolecular binding events including, for example, protein-protein interactions and protein-small molecule interactions.

To properly conduct this type of high sensitivity measurement, it is important that problematical factors (e.g. temperature, solvent effects, bulk index of refraction changes, and nonspecific binding) which can lead to spurious changes in the measured refractive index/optical response be controlled and/or referenced out. Several different methods that can be used to reference out these problematical factors have been discussed in a co-assigned U.S. patent application Ser. No. 11/027,509 filed on Dec. 29, 2004 and entitled “Method for Creating a Reference Region and a Sample Region on a Biosensor and the Resulting Biosensor”. The contents of this document are incorporated by reference herein.

U.S. patent application Ser. No. 11/027,509 discloses several different methods for configuring a biosensor such that the aforementioned problematical factors can be referenced out when the biosensor is interrogated by an optical interrogation system. One of these methods for configuring the biosensor includes using a pin printing deposition technique to create a reference region on a reactive region of the biosensor's surface. This method includes the steps of coating the surface of the biosensor with a reactive agent and then using the pin printing deposition technique to deposit a blocking/deactivating agent on a predefined area of the reactive surface on the biosensor. Upon completion of these steps, the biosensor has a reference region (exposed blocking/deactivating agent) and a sample region (exposed reactive agent). Thus, when an assay is conducted and the biosensor is interrogated, a sample signal can be obtained from the sample region (which has thereon both an immobilized target molecule and a solution of a chemical/biochemical compound) that is used to detect a chemical/biomolecular binding event. And, a reference signal can be obtained from the reference region (which has thereon the chemical/biochemical compound solution but not the immobilized target molecule) that is used to detect spurious changes which could adversely affect the detection of the chemical/biomolecular binding event. Then, a “corrected” sample signal can be obtained by subtracting the reference signal from the sample signal. The “corrected” sample signal indicates the measured refractive index/optical response associated with the sample region where the problematical factors which cause spurious changes have been referenced-out.

This particular pin printing deposition technique has many advantages but it also has many disadvantages some of which are as follows:

1.The pin printing deposition technique uses a relatively large volume of ink (deactivating agent) on the biosensor, several nL per strike.

2. Since the printed spots remain fluid for tens of seconds before solvent evaporation, this allows the printed spots to merge and form the reference region. However, if there is too much liquid then this allows the printed reference region to spread, deform and de-wet which negatively affects the uniformity/definition of the deposited feature, increases the noise in the assay response, and requires the optical interrogation system to accommodate reference and sample regions which have varying sizes. In addition, the spreading of the printed spots also results in wide transition bands between the reference and sample regions, which wastes valuable space on the biosensor. Moreover, the excess unevaporated ink may spread or contaminate the signal/sample region while the biosensor/microplate is being stored.

3. The diameter of the printed spots are on the order of hundreds of microns, which makes it difficult to create complicated features such as checker boards with sub-millimeter dimensions.

4. The diameter of the printed spot does not necessarily remain constant during spotting. And, if the spot becomes too small, then the printed spots do not merge. To solve this problem, one might have to re-ink the pins before preparing a new reference region. This increases cycle times.

As can be seen, there is a need for a new deposition technique that can be used to prepare a biosensor which has a surface with at least one reference region and at least one sample region. This need and other needs are satisfied by the deposition device and the method of the present invention.

### BRIEF DESCRIPTION OF THE INVENTION

A method and deposition device are described herein that use an aerosol jet direct write technique to create non-binding reference region(s) and/or binding sample region(s) within a single well or multiple wells of a microplate, or on a single or multiple biosensors of an unassembled bottom insert. In one embodiment, the aerosol jet direct write technique enables a faster deposition of blocker/deactivating solution on a reactive surface, at lower volumes with higher positional placement accuracy, greater reference pad uniformity, and a wider range of ink formulations than is possible when using a pin printing deposition technique.

### BRIEF DESCRIPTION OF THE DRAWINGS

A more complete understanding of the present invention may be obtained by reference to the following detailed description when taken in conjunction with the accompanying drawings wherein:

FIG. 1 is a block diagram of an exemplary deposition device which uses an aerosol jet direct write technique to create one or more reference region(s) and/or sample region(s) on a surface of a biosensor in accordance with the present invention;

FIG. 2A is a flowchart that illustrates the steps of a preferred method for using an aerosol jet direct write technique to create reference region(s) on a reactive surface of a biosensor in accordance with one embodiment of the present invention;

FIG. 2B is a flowchart that illustrates the steps of a preferred method for using an aerosol jet direct write technique to create reference region(s) and/or sample region(s) on a surface of a biosensor in accordance with a second embodiment of the present invention;

FIGS. 3A-3E show photos that illustrate the results of an experiment which was conducted to evaluate/compare the effectiveness of using the new aerosol jet direct write technique (as discussed in method 200a) and the known pin printing technique to create reference region(s) on top of the reactive surfaces on slides;

FIGS. 4A-4F show 2D wavelength/power scans and graphs that illustrate the results of an experiment which was conducted to evaluate/compare the effectiveness of using the new aerosol jet direct write technique (as discussed in method 200a) and the known pin printing technique to create reference region(s) on top of the reactive surfaces on biosensors within 96-well microplates;

FIGS. 5A-5H show 2D wavelength/power scans that illustrate the results of an experiment which was conducted to evaluate/compare the effectiveness of using the new aerosol jet direct write technique (as discussed in method 200a) and the known pin printing technique to create reference region(s) using different types of aqueous deactivating inks on top of the reactive surfaces on biosensors within 96-well microplates;

FIGS. 6A-6J show 2D wavelength/power scans and graphs that illustrate the results of an experiment which was conducted to evaluate/compare the effectiveness of using the new aerosol jet direct write technique (as discussed in method 200a) and the known pin printing technique to create reference region(s) on top of the reactive surfaces on biosensors within 384-well microplates; and

FIGS. 7A-7B show a graph and a 2D wavelength scan that illustrate the results of an experiment which was conducted to evaluate the use of the new aerosol jet direct write technique (as discussed in method 200a) to create a reference region on top of a reactive surface on a biosensor located within a bottom insert (which was later assembled with a “holey plate” to form a 384-well microplate).

### DETAILED DESCRIPTION OF THE DRAWINGS

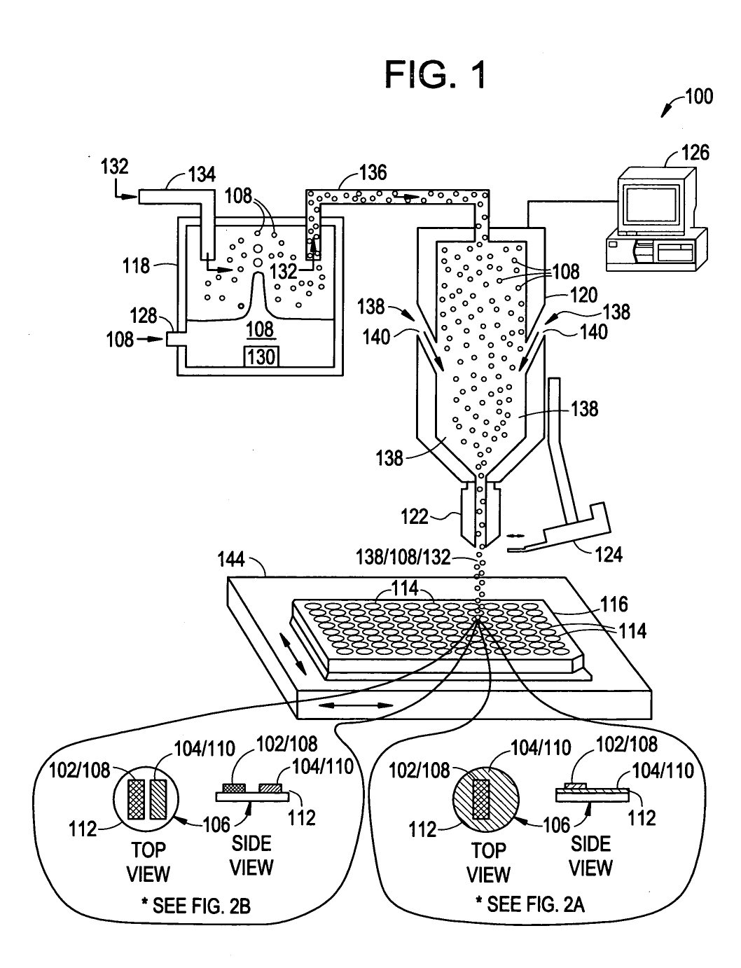

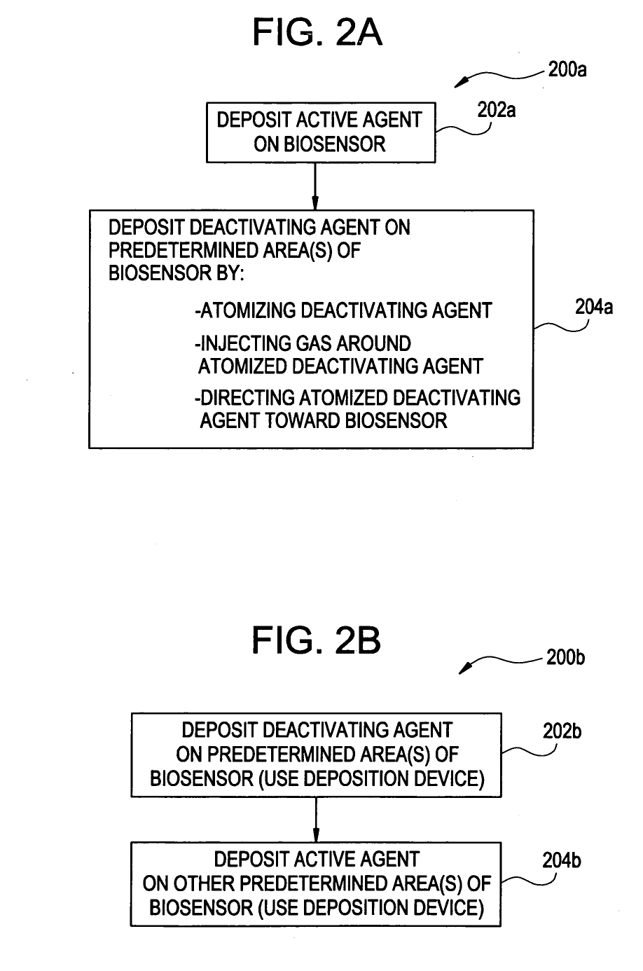

Referring to FIGS. 1-2A, there are respectively illustrated a block diagram of a deposition device 100 and a flowchart of a method 200a that can be used to form reference region(s) 102 (only one shown) on top of an active agent 110 coating a surface 112 of a biosensor 106 in accordance with the present invention. However, prior to discussing the present invention, it should be noted that the preferred biosensors 106 are the ones which can be used to implement LID optical techniques like a resonant waveguide grating (RWG) biosensor 106 or a surface plasmon resonance (SPR) biosensor 106. The following documents describe these exemplary biosensors 106:
European Patent Application No. 0 202 021 A2 entitled “Optical Assay: Method and Apparatus”.
U.S. Pat. No. 4,815,843 entitled “Optical Sensor for Selective Detection of Substances and/or for the Detection of Refractive Index Changes in Gaseous, Liquid, Solid and Porous Samples”.

The contents of these documents are incorporated by reference herein.

FIG. 1 shows the basic components of an exemplary deposition device 100 which can use an aerosol jet direct write technique to deposit a deactivating agent 108 at predefined area(s) on top of an active agent 110 that was previously deposited (possibly by the aerosol jet direct write technique) on top of a surface 112 of the biosensor 106 (see steps 202a and 204a in FIG. 2A). In this example, the biosensor 106 is shown located within the well 114 of a microplate 116. The deposition device 100 has an atomizing chamber 118, a deposition head 120, a nozzle 122, a moveable shuttering mechanism 124 (mechanical shutter 124, pneumatic valve 124) and a processor 126. The atomizing chamber 118 has an opening 128 through which it can receive the deactivating agent 108. The atomizing chamber 118 also has an atomizing transducer 130 (e.g., ultrasonic transducer 130, pneumatic transducer 130, acoustic horn 130) located therein which atomizes a portion of the deactivating agent 108. In addition, the atomizing chamber 118 has an inlet tube 134 through which it can receive a flowing gas 132 (carrier gas 132) and an outlet tube 136 through which it can output the carrier gas 132 and the atomized deactivating agent 108.

The deposition head 120 which is connected to the atomizing chamber 118 (and in particular to the outlet tube 136) receives the flowing carrier gas 132/atomized deactivating agent 108. The deposition head 120 has a passageway 140 through which a sheath gas 138 is injected such that it flows around the atomized deactivating agent 108 and the carrier gas 132. The sheath gas 138 helps to collimate and focus the atomized deactivating agent 108/carrier gas 132 by forming a jacket around the atomized deactivating agent 108/carrier gas 132.

The nozzle 122 which is connected to the deposition head 120 directs the flowing sheath gas 138 and the flowing carrier gas 132/atomized deactivating agent 108 towards a predetermined area 102 (reference region 102) on top of the reactive surface 110/112 of the biosensor 106 (note the drawing is not to scale). In one scenario, the deposition device 100 remains stationary while the nozzle 122 deposits the atomized deactivating agent 108 on predefined area(s) 102 of the biosensor 106 which is moved back-and-forth by a platform 144. The processor 126 is programmed to control the back-and-forth movement of the platform 144. For instance, the processor 126 can implement a computer-aided design (CAD) created tool path to control the back-and-forth movement of the platform 144 The processor 126 is also programmed to control the movement of the shuttering mechanism 124 to permit or block the deposition of the deactivating agent 108 so it is deposited only on the predefined area which is to become the reference region 102. In another scenario, the deposition device 100 can be moved while the nozzle 122 deposits the atomized deactivating agent 108 on the predefined area(s) of a stationary biosensor 106. Upon completion of either scenario, the biosensor 106 has a reference region 102 (exposed blocking/deactivating agent 108) and a sample region 104 (exposed active agent 110).

In an alternative embodiment, the deposition device 100 can use the aerosol jet direct write technique to create one or more reference regions 102 by depositing a deactivating agent 108 on one or more predetermined areas of a non-reactive surface 112 (see step 202b in FIG. 2B). Then, the deposition device 100 can use the aerosol jet direct write technique to create one or more sample regions 104 by depositing an active agent 110 on one or more predetermined areas of the non-reactive surface 112 (see step 204b in FIG. 2B). It should be noted that known solution chemistry can be used instead of the aerosol jet direct write technique to deposit the reactive agent 110 on the one or more predetermined areas of the non-reactive surface 112.

At this point, when an assay is conducted and the biosensor 106 is interrogated, a sample signal can be obtained from the sample region 104 (which has thereon both an immobilized target molecule and a solution of a chemical/biochemical compound) that is used to detect a chemical/biomolecular binding event (or in an alternative embodiment a cell based assay can be performed). And, a reference signal can be obtained from the reference region 142 (which has thereon the chemical/biochemical compound solution but not the immobilized target molecule) that is used to detect spurious changes which could adversely affect the detection of the chemical/biomolecular binding event. Then, a “corrected” sample signal can be obtained by subtracting the reference signal from the sample signal. The “corrected” sample signal indicates the measured refractive index/optical response associated with the sample region 104 where the problematical factors which cause spurious changes have been referenced-out. An optical interrogation system which can be used to interrogate the biosensor 106 is disclosed in co-assigned U.S. patent application Ser. No. 11/027,547 (filed Dec. 29, 2004) and U.S. Patent Application Ser. No. 60/701,445 (filed Jul. 20, 2005). The contents of these documents are incorporated by reference herein.

An exemplary deposition device 100 which could be used in this particular application is manufactured by Optomec, Inc. and is sold under the brand name of The Maskless Meso-Scale Material Deposition System™ (M³D™) This particular deposition device 100 when used in accordance with method 200a (for example) has the many capabilities/advantages some of which are as follows:

1. The aerosol jet direct write technique consumes 100 times less deactivating agent 108 than the known pin printing deposition technique.

2. The deposited deactivating agent 108 dries 10-100 times more quickly than a deactivating agent deposited by the pin printing deposition technique. Thus, the reference region 102 created by the aerosol jet direct write technique has an improved feature definition/uniformity.

3. The thicknesses of the deposited deactivating agent 108, after solvent evaporation, can be varied from 1 nm-3000000 nm, with minimal impact on feature uniformity. And, the deposited deactivating agent 108 can have a droplet size which is 1-25 μm in diameter and have a volume which is approximately 10-15000 fL.

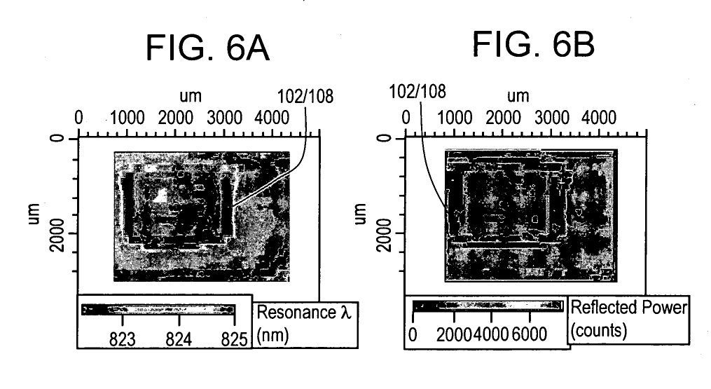

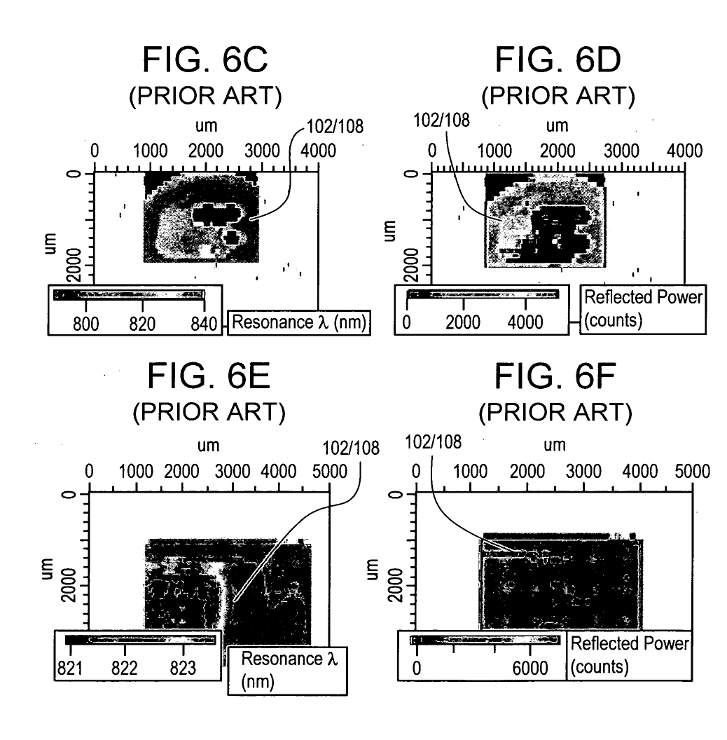

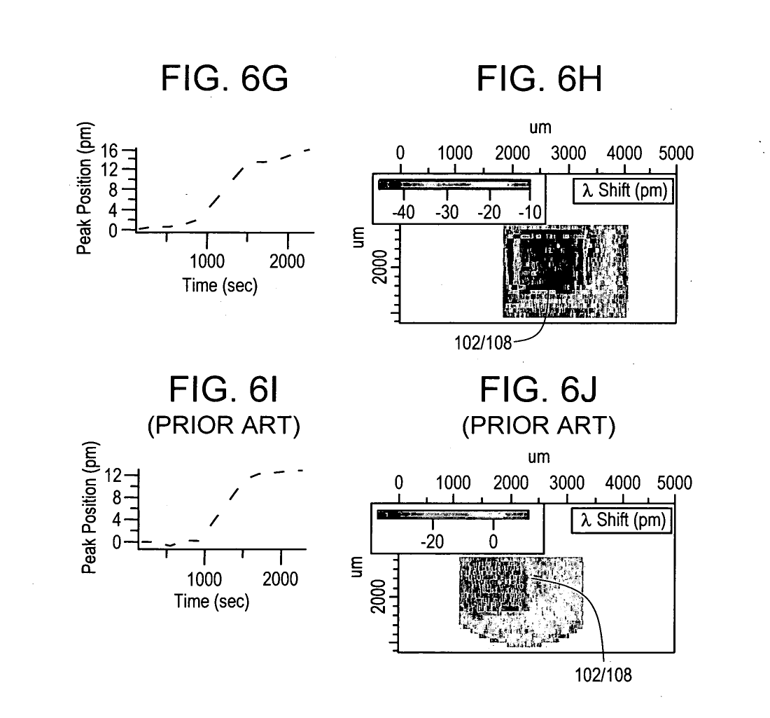

4.The aerosol jet direct write technique can create reference region(s) 102 using inks based on a variety of buffers and/or solvents with a minimal variation in uniformity or definition (so long as the buffers can be atomized). This technique can also form small reference regions 102 on biosensors 102 in a 384-well microplate format, without the need for adding spreading agents or surfactants, like di-methyl sulfoxide (DMSO)(see FIGS. 6A-6J).

5. The width of the deposited deactivating agent 108 can be as narrow as 10 μm. Thus, the aerosol jet direct write technique can create reference region(s) 102 a few hundred microns in dimension, with abutting or overlapping lines.

6. The aerosol jet direct write technique is non-contact. Thus, it is far less likely to damage or physically modify the biosensor 106 when compared to the pin printing deposition technique.

7. The quantity of ink applied can be controlled so that there is much less likelihood of spreading during microplate/biosensor storage.

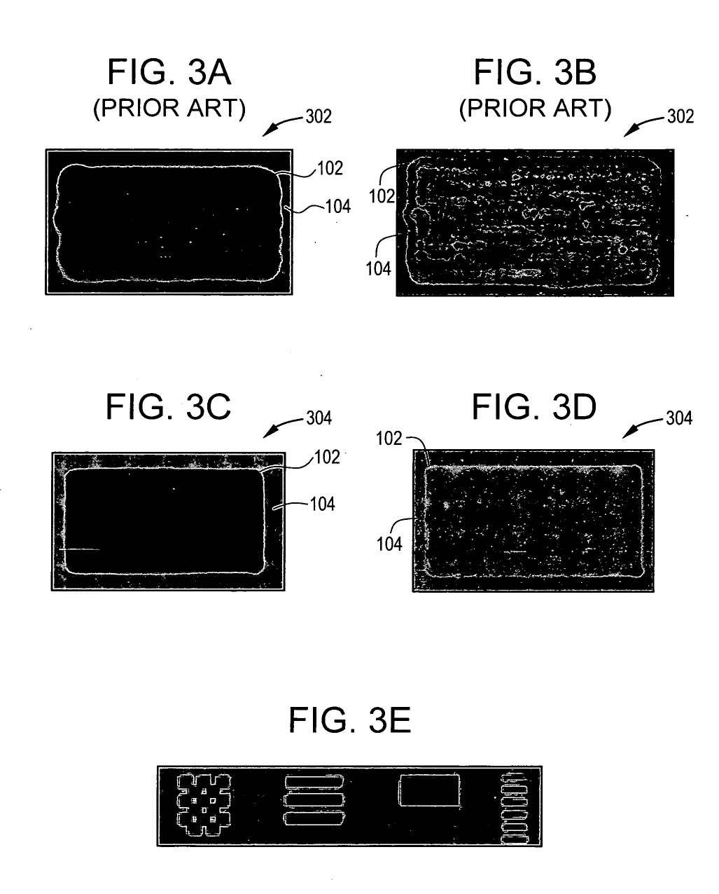

Referring to FIGS. 3A-3E, there are shown various photos that illustrate the results of a first experiment which was conducted to evaluate/compare the effectiveness of using the new aerosol jet direct write technique (as discussed in method 200a) and the known pin printing technique to create reference region(s) on top of the reactive surfaces on slides. In this experiment, the slides (in particular Corning's ultra-GAPS™ slides) were prepared by soaking them in a 1 mg/mL solution of (ethylene-alt-maleic anhydride) (“EMA”) and 9:1 isopropanol (“IPA”):N-methyl2-pyrrolidinoone (“NMP”) for 10 minutes, followed by rinsing them in absolute ethanol, and then drying them under a stream of nitrogen. The EMA is the active agent 110.

One slide 304 was then placed under the deposition system 100 (in particular The Maskless Meso-Scale Material Deposition System™ (M³D™)) which used the aerosol jet direct write technique to deposit O,O′-bis(2-aminopropyl)polyethylene glycol 1900 (PEG1900DA) (deactivating agent 108) dissolved in filtered 100 mM Borate Buffer onto a predefined area 102 (reference region 102) of the slide. In this case, the deposition system 100 deposited the PEG1900DA (deactivating agent 108) by raster filling overlapping lines (˜50-150 μm wide) at a 25 μm pitch. Another slide 302 was placed under a device which used the known printing technique to deposit PEG1900DA (deactivating agent 108) dissolved in filtered 100 mM Borate Buffer onto a predefined area 102 (reference region 102) of the slide.

Next, Cy3-Streptavidin was immobilized on the exposed reactive surface 104 of the printed slides 302 and 304 by soaking them in 50 μg/ml Cy3-Streptavidin and a PBS buffer, and then washing them in an ethanolamine solution (200 mM in borate buffer). The reference region 102 which is coated with the PEG1900DA (deactivating agent 108) does not permit the binding or immobilization of the Cy3-Streptavidin. Thereafter, a biotin solution was added to the slides 302 and 304.

The slides 302 and 304 were then imaged in an Axon GenePix 4000B fluorescence scanner. FIGS. 3A and 3B (PRIOR ART) show the fluorescence scans of the pin printed rectangles 108 (15×30 array of spots) which are associated with the rectangular reference region 102 (see center portion of photos) on slide 302. In these photos, the fluorescence image after Cy3-Streptavidin immobilization is shown on the left, and the fluorescence image before Cy3-Streptavidin immobilization is shown on the right. In contrast, FIGS. 3C and 3D show the fluorescence scans of the aerosol jet direct written rectangles 108 (150 μm line width, 25 μm raster pitch) which are associated with the rectangular reference regions 102 (see center portion of photos) on slide 304. In these photos, the fluorescence image after Cy3-Streptavidin immobilization is shown on the left, and the fluorescence image before Cy3-Streptavidin immobilization is shown on the right.

The pin printed reference region 102 shown in FIGS. 3A and 3B (PRIOR ART) has wavy edges, gradual transitions from blocked and unblocked regions. Plus, the pin printed reference region 102 has horizontal non-uniformities in the coating/blocking that is a result of poor merging between adjacent rows of the overlapping printed spots. This is not desirable. In contrast, the aerosol jet deposited reference region 102 shown in FIGS. 3C and 3D had sharper edges and exhibited a superior uniformity with a comparable blocking efficiency when compared to the pin printed reference region 102.

The photo shown in FIG. 3E illustrates several different features that have been created by the aerosol jet direct write technique. For example, the features that are shown from left to right include a 0.5 mm×0.5 mm checker board, 0.5 mm wide stripes, a 3 mm×1.5 mm rectangle and 150 μm wide discrete lines. These different features would be difficult to make using the pin printing deposition technique which deposits overlapping spots of ˜225 μm diameters. However, the blocking efficiency of the features which are made by the aerosol jet direct write technique is comparable to the blocking efficiency of the features which are made by the pin printing deposition technique.

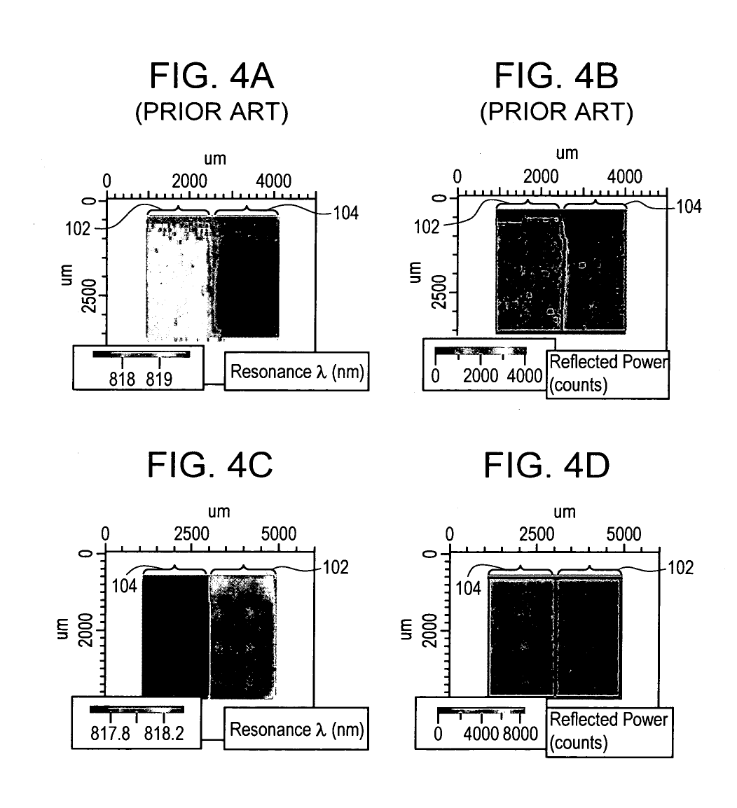

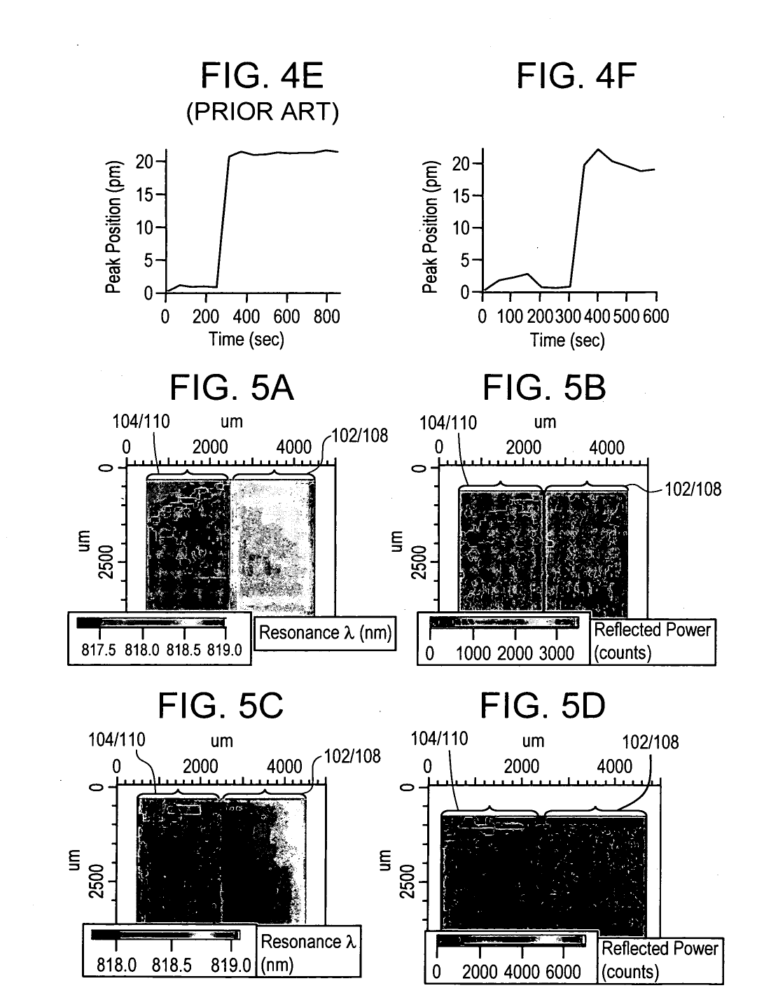

Referring to FIGS. 4A-4F, there are shown various 2D wavelength/power scans and graphs that illustrate the results of a second experiment which was conducted to evaluate/compare the effectiveness of using the new aerosol jet direct write technique (as discussed in method 200a) and the known pin printing technique to create reference region(s) on top of the reactive surfaces on biosensors 106 within 96-well microplates. In this experiment, two 96-well microplates (in particular 96-well Corning Epic™ microplates) were prepared by dip coating them within an aqueous solution of aminopropylsilsesquixane (“APS”, Gelest) (5% vol/vol) for 10 minutes, rinsing them with filtered de-ionized (DI) water, followed by another rinsing in absolute ethanol, and then drying them under a stream of nitrogen. Thereafter, a Tecan washer robot was used to coat the biosensors 106 with 1 mg/mL solution of EMA (active agent 110) in 9:1 IPA:NMP for 10 minutes. The microplates were then rinsed in absolute ethanol, and dried by a vacuum centrifuge.

One microplate was then placed under the deposition system 100 (in particular The Maskless Meso-Scale Material Deposition Systems (M³D™)) which used the aerosol jet direct write technique to deposit PEG1900DA (deactivating agent 108) dissolved in a borate buffer onto a predefined area 102 (reference region 102) of one of the biosensors 106. In this case, the deposition system 100 deposited the PEG1900DA (deactivating agent 108) by raster filling overlapping lines (˜50-150 μm wide) at a 25 μm pitch. Another microplate was then placed under a device which used the known printing technique to deposit PEG1900DA (deactivating agent 108) dissolved in a borate buffer onto a predefined area 102 (reference region 102) of one of the biosensors 106.

Next, streptavidin was immobilized on the reactive surface 104 of the biosensors 106 within the microplates by exposing them to a solution of 100 μM Streptavidin in borate buffer (100 mM, pH9) for 20 minutes, followed by a PBS buffer wash, a block/wash with ethanolamine (200 mM in borate buffer, pH9), and then an additional wash with PBS buffers. Then, the microplates were incubated for 1 hour in a solution of PBS located with the wells. The reference region 102 which is coated with the PEG1900DA (deactivating agent 108) does not permit the binding or immobilization of the Streptavidin.

An optical interrogation system (in particular a Corning Epic™ reader instrument) interrogated the biosensors 106 within the microplates where 2D scans were performed before and after a biotin solution was added to each of the wells. FIGS. 4A and 4B (PRIOR ART) respectively show the 2D wavelength scan and the power scan of the pin printed intra-well interrogation of one biosensor 106 (where the reference region 102 is on the left side and the sample region 104 is on the right side). In these scans, non-uniformities can be easily seen in both the wavelength and power. Some bleeding from the printed reference region 102 can also be seen.

In contrast, FIGS. 4C and 4D respectively show the 2D wavelength scan and the power scan of the aerosol jet deposited intra-well interrogation of one biosensor 106 (where the reference region 102 is on the right side and the sample region 104 is on the left side). In these scans, it can be seen that there was little bleeding from the reference region 102 and that there was comparable wavelength and power uniformity between the reference region 102 and the sample region 104. Furthermore, it can be seen that the aerosol jet direct written features have a superior wavelength and power uniformity, as well as straighter and sharper edges when compared to the pin printed features.

The graphs shown in FIGS. 4E and 4F illustrate the intra-well referenced time traces for assays performed with biosensors 106 that had references regions 102 which were created by the known pin printing deposition technique (see FIG. 4E) and the new aerosol jet direct write technique (see FIG. 4F). The intra-well referenced time traces of f-biotin binding to streptavidin for both cases had a comparable binding signal (˜20 pm), and in both cases the time traces exhibited reduced signal drift during the baseline and binding reads.

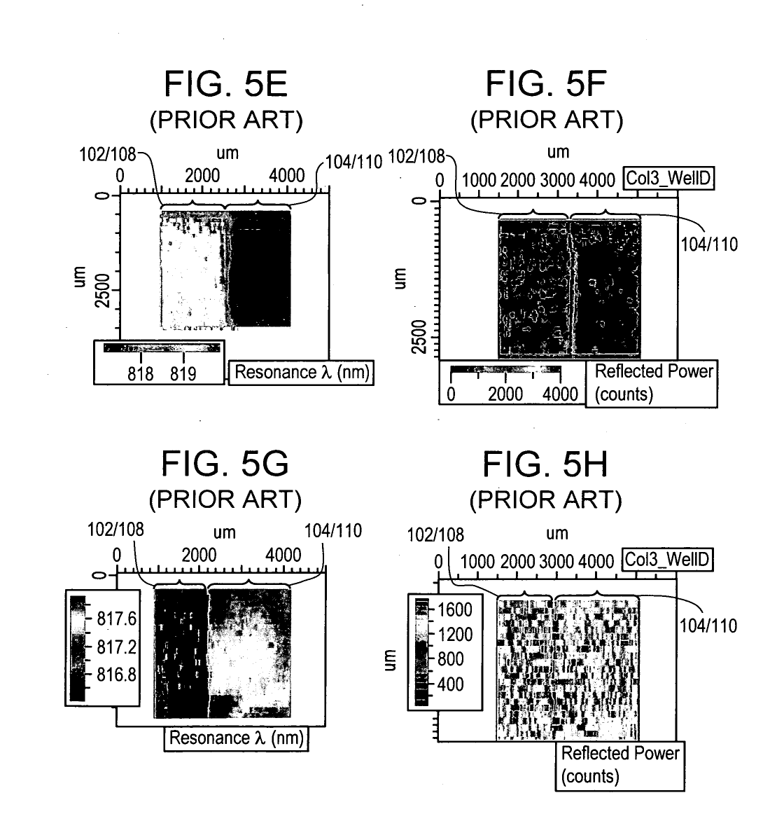

Referring to FIGS. 5A-5H, there are shown various 2D wavelength and power scans that illustrate the results of a third experiment which was conducted to evaluate/compare the effectiveness of using the new aerosol jet direct write technique (as discussed in method 200a) and the known pin printing technique to create reference region(s) 102 with different types of aqueous deactivating inks on top of the reactive surfaces on biosensors 106 within 96-well microplates. In this experiment, the 96-well microplates were prepared and interrogated in the same manner as in the second experiment except that in one test the PEG1900DA (deactivating agent 108) had been dissolved in 100 mM borate (see FIGS. 5A-5B and FIGS. 5E-5F) and in another test the PEG1900DA (deactivating agent 108) had been dissolved in 50 nM Tris (see FIGS. 5C-5D and FIGS. 5G-5H). As can be seen in FIGS. 5A-5D, the reference regions 102 (associated with the deactivating agent 108) which were created by the aerosol jet direct write technique did not show noticeable differences in coating uniformity and feature definition. In contrast, as can be seen in FIGS. 5E-5H (PRIOR ART), the reference regions 102 (associated with the deactivating agent 108) which were created by the known pin printing deposition technique did show noticeable differences in coating uniformity and feature definition (especially when the PEG1900DA was dissolved in 50 nM Tris). These results demonstrate that the aerosol jet direct write technique has a lot of flexibility when it comes to using different types of aqueous deactivating inks 108 when compared to the pin printing deposition technique.

Referring to FIGS. 6A-6J, there are shown various 2D wavelength/power scans and graphs that illustrate the results of a fourth experiment which was conducted to evaluate/compare the effectiveness of using the new aerosol jet direct write technique (as discussed in method 200a) and the known pin printing technique to create reference region(s) on top of reactive surfaces on biosensors 106 within 384-well microplates. In this experiment, the 384-well microplates (in particular 384-well Corning Epic™ microplates) were prepared and interrogated in the same manner as the 96-well microplates which were prepared in the second experiment except for the following differences: (1) one 384-well microplate was prepared by using the new aerosol jet direct write technique which deposited a PEG1900DA (deactivating agent 108) that had been dissolved in 100 mM borate (see FIGS. 6A-6B); (2) another 384-well microplate was prepared using the pin printing technique which deposited a PEG1900DA (deactivating agent 108) that had been dissolved in 100 mM borate (see FIGS. 6C-6D); and (3) another 384-well microplate was prepared by using the pin printing technique which deposited a PEG1900DA (deactivating agent 108) that had been dissolved in 100 mM borate which had 2 vol. % DMSO (see FIGS. 6E-6F).

As can be seen, the reference region 102 had defined features and a uniform coating when the 384-well microplate was prepared using the new aerosol jet direct write technique where the PEG1900DA (deactivating agent 108) had been dissolved in 100 mM borate (see FIGS. 6A-6B). But, in the 384-well microplate that was prepared by using the pin printing technique where the PEG1900DA (deactivating agent 108) had been dissolved in 100 mM borate, the reference region 102 did not have well defined features or a uniform coating (see FIGS. 6C-6D). To correct this problem, the 384-well microplate can be prepared by using the pin printing technique where the PEG1900DA (deactivating agent 108) is dissolved in 100 mM borate and 2 vol. % DMSO (see FIGS. 6E-6F). The reference region 102 which was created with PEG1900DA dissolved in 100 mM borate buffer with 2 vol. % DMSO showed significantly improved uniformity when compared to the reference region 102 that was printed without DMSO (see FIGS. 6C-6D). However, the reference region 102 shown in FIGS. 6E-6F exhibited a wider “bleed out” region at the border which is due to the addition of the DMSO wetting agent.

The graph/scan shown in FIGS. 6G-GH respectively illustrate the intra-well referenced time trace and 2D binding map for an assay performed with a biosensor 106 that had a reference region 102 (PEG1900DA/100 mM borate) which was created by the aerosol jet direct write technique. And, the graph/scan shown in FIGS. 6I-6J (PRIOR ART) respectively illustrate the intra-well referenced time trace and 2D binding map for an assay performed with a biosensor 106 that had a reference region 102 (PEG1900DA/100 mM borate/2% DMSO) which was created by the pin printing deposition technique. As can be seen in FIGS. 6G and 6I, the intra-well referenced time traces of f-biotin binding to streptavidin for both cases had a comparable binding signal (˜14 pm), and in both cases the time traces exhibited reduced signal drift during the baseline and binding reads.

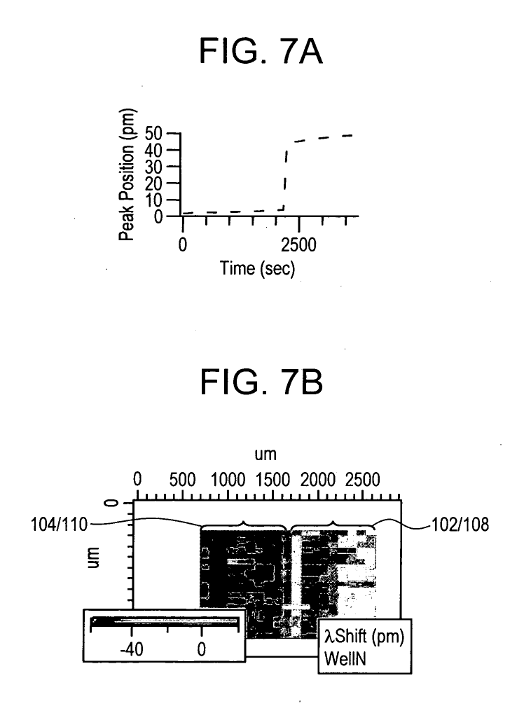

Referring to FIGS. 7A-7B, there are respectively shown a graph and a 2D wavelength scan that illustrate the results of a fifth experiment which was conducted to evaluate the use of the new aerosol jet direct write technique (as discussed in method 200a) to create a reference region 102 on top of the reactive surface of a biosensor 106 located within a bottom insert (which can be assembled with a “holey plate” to form a 384-well Corning Epic™ microplate). In this experiment, the bottom insert with biosensors 106 located therein was prepared by dip coating it with an aqueous solution of APS (5% vol/vol) for 10 minutes, rinsing it with filtered DI water, followed by another rinsing with absolute ethanol, and then drying it under a stream of nitrogen. The bottom insert was coated with a 1 mg/mL solution of EMA (active agent 110) in 9:1 IPA:NMP for 10 minutes, rinsed with an absolute ethanol, and dried under a stream of nitrogen.

The bottom insert was then placed under the deposition system 100 (in particular The Maskless Meso-Scale Material Deposition System™ (M³D™)) which used the new aerosol jet direct write technique to deposit PEG1900DA (deactivating agent 108) dissolved in a borate buffer onto a predefined area 102 (reference region 102) of each biosensor 106. In particular, the deposition system 100 deposited the PEG1900DA (deactivating agent 108) by raster filling overlapping lines (˜50-150 μm wide) at a 25 μm pitch. In this experiment, the deposition device 100 was able to create reference regions 102 that covered exactly half of the biosensors 106 because there was no physical limitation associated with the presence of the well's walls.

As can be seen in FIG. 7A-7B, this process yielded far superior uniformity and definition than is possible with the pin printing deposition technique (e.g., see FIGS. 4A-4B and 5E-5H). The intra-well referenced time trace and the 2D binding map also indicate that most of the spurious signal drift had been referenced out, and the blocking in the reference region 102 was adequate and uniform. Although the detected binding response of f-Biotin to Streptavidin was ˜50 pm, which is significantly higher than in the previous experiments, it is believed that this is related to the chemistry of the reactive polymer layer rather than the difference in the deactivating agent 108 and deposition technique.

As can be seen, all of these experiments used EMA as the active agent 110 and PEG1900DA as the deactivating agent 108. However, the EMA agent 110 and the PEG1900DA agent 108 are not the only agents which can be used. Examples of different active agents 110 that could be used include, but are not limited to, the agents that are present anhydride groups, active esters, maleimide groups, epoxides, aldehydes, isocyanates, isothiocyanates, sulfonyl chlorides, carbonates, imidoesters, or alkyl halides.) And, examples of different deactivating agents 108 that could be used include, but are not limited to, ethanolamine (EA), ethylenediamine (EDA), tris hydroxymethylaminoethane (tris), polyethylene glycol amines or diamines, or non-amine containing reagents.

Although multiple embodiments of the present invention have been illustrated in the accompanying Drawings and described in the foregoing Detailed Description, it should be understood that the invention is not limited to the disclosed embodiments, but is capable of numerous rearrangements, modifications and substitutions without departing from the spirit of the invention as set forth and defined by the following claims.

What is claimed is:

1. A method for preparing a biosensor which has a surface with a sample region and a reference region, said method comprising the step of:
utilizing an aerosol jet deposition technique to create the reference region and/or the sample region on the surface of said biosensor.

2. The method of claim 1, wherein said reference region and said sample region are created on the surface of said biosensor by performing the following steps:
creating the reference region by using the aerosol jet deposition technique to deposit a deactivating agent on a first predetermined area of the surface; and
creating the sample region by depositing a reactive agent on a second predetermined area of the surface.

3. The method of claim 2, wherein said sample region is created on the surface of said biosensor by using said aerosol jet deposition technique.

4. The method of claim 1, wherein said reference region and said sample region are created on the surface of said biosensor by performing the following steps:
creating the sample region by coating the surface with a reactive agent; and
creating the reference region by using the aerosol jet deposition technique to deposit a deactivating agent on a predetermined area of the coated reactive surface.

5. The method of claim 4, wherein said sample region is created on the surface of said biosensor by using said aerosol jet deposition technique to deposit the reactive agent on the surface.

6. The method of claim 4, wherein said step of creating the reference region by using the aerosol jet deposition technique includes the steps of:
atomizing the deactivating agent;
using a carrier gas to transport said atomized deactivating agent;
injecting a sheath gas around said carrier gas and said atomized deactivating agent; and
directing said sheath gas, said carrier gas and said atomized deactivating agent towards the predetermined area on the coated surface.

7. The method of claim 4, wherein said step of creating the reference region by using the aerosol jet deposition technique includes the step of:
controlling a thickness/uniformity/spreading of the deposited deactivating agent.

8. The method of claim 1, further comprising the step of exposing the surface to target molecules where the target molecules bind to the sample region created on the surface and do not bind to the reference region created on the surface.

9. The method of claim 1, further comprising the step of interrogating said biosensor such that a sample signal from the sample region is used to detect a chemical/biomolecular binding event and a reference signal from the reference region is used to reference out from the sample signal spurious changes that adversely affect the detection of the chemical/biomolecular binding event.

10. The method of claim 1, further comprising the step of interrogating said biosensor such that a sample signal from the sample region is used to perform a cell assay and a reference signal from the reference region is used to reference out from the sample signal spurious changes that adversely affect the cell assay.

11. A deposition device, comprising:
an atomizing chamber in which an agent is atomized and in which a carrier gas is inserted to transport the atomized agent;
a deposition head that receives the carrier gas and the atomized agent and injects a sheath gas around the carrier gas and the atomized agent; and
a nozzle that directs the sheath gas, the carrier gas and the atomized agent towards a predetermined area on a surface of a biosensor.

12. The deposition device of claim 11, further comprising a platform which supports and moves the biosensor so the atomized agent can be deposited on the biosensor.

13. The deposition device of claim 11, further comprising a shuttering mechanism that moves to either permit or block said sheath gas, said carrier gas and said atomized agent emitted from said nozzle from reaching the surface of the biosensor.

14. The deposition device of claim 11, further comprising a processor that ensures a desired thickness/uniformity/line width of the atomized agent is deposited/patterned onto the biosensor.

15. The deposition device of claim 11, wherein said agent is a deactivating agent which is deposited so as to form a reference region on the biosensor.

16. The deposition device of claim 11, wherein said agent is a reactive agent which is deposited so as to form a sample region on the biosensor.

17. A biosensor, comprising:
a surface that has a reference region and/or a sample region which was created in part by using an aerosol jet deposition technique.

18. The biosensor of claim 17, wherein the reference region and the sample region were created on said surface by performing the following steps:
creating the reference region by using the aerosol jet deposition technique to deposit a deactivating agent on a first predetermined area of the surface; and
creating the sample region by depositing a reactive agent on a second predetermined area of the surface.

19. The biosensor of claim 18, wherein said sample region is created on said surface by using said aerosol jet deposition technique.

20. The biosensor of claim 17, wherein said reference region and said sample region are created on said surface by performing the following steps:
creating the sample region by coating the surface with a reactive agent; and
creating the reference region by using the aerosol jet deposition technique to deposit a deactivating agent on a predetermined area of the coated reactive surface.

21. The biosensor of claim 20, wherein said sample region is created on said surface by using said aerosol jet deposition technique to deposit the reactive agent on the surface.

22. The biosensor of claim 20, wherein said deposited deactivating agent has a thickness in a range of 1 nm-3000000 nm.

23. The biosensor of claim 20, wherein said deposited deactivating agent has a line width that is ≧10 μm.

24. The biosensor of claim 20, wherein said deposited deactivating agent has a droplet size which is 1-25 μm.

25. The biosensor of claim 17, wherein said surface has more than one reference region and/or more than one sample region.

26. The biosensor of claim 17, wherein said surface is a slide.

27. The biosensor of claim 17, wherein said surface is a bottom of a well in a microplate.

28. The biosensor of claim 17, wherein said surface is an unassembled bottom insert which is used to make a microplate.
